(19) United States
(12) Patent Application Publication
(10) Pub. No.: US 2014/0218434 A1
(43) Pub. Date: Aug. 7, 2014

(54) PRINTING APPARATUS AND COLORIMETRIC METHOD

(71) Applicant: CANON KABUSHIKI KAISHA, Tokyo (JP)

(72) Inventor: Junya Kosuge, Kawasaki-shi (JP)

(73) Assignee: CANON KABUSHIKI KAISHA, Tokyo (JP)

(21) Appl. No.: 14/162,624

(22) Filed: Jan. 23, 2014

(30) Foreign Application Priority Data
Feb. 5, 2013 (JP) 2013-020587

(51) Int. Cl. B41J 2/21

(52) U.S. Cl. CPC B41J 2/21
USPC 347/17

(57) ABSTRACT

A printed color pattern is subjected to accurate colorimetry irrespective of the type of sheet to be used or the like, and further, sheet consumption is reduced. For the purpose of this, a printing apparatus includes: a print unit configured to perform printing on a sheet; a sensor configured to subject a color pattern formed on the sheet printed; and a mechanism configured to press the sheet against a reference surface at the time of the colorimetry by the sensor. In a case where the color pattern is printed, a position, at which the color pattern in a sheet movement direction is started to be printed, is varied based on the type of sheet to be used. After the color pattern is printed, the sheet is pressed by the mechanism in a state in which a part of the sheet including the sheet tip is suspended from the reference surface.

### BACKGROUND OF THE INVENTION

1. Field of the Invention

The present invention relates to a printing apparatus equipped with a colorimetric function of measuring the color of a color pattern printed on a sheet, and a colorimetric method.

2. Description of the Related Art

Some of printing apparatuses for performing a color printing operation are equipped with a colorimetric function in order to perform color calibration. In performing colorimetry, a color pattern is printed on a sheet, and then, color information on the color pattern is measured by a colorimeter. The resultant measured data and print data displayed on a monitor are compared with each other with respect to colors. The comparison result is reflected on a next printing operation, so as to achieve desired color reproduction.

Japanese Patent Laid-open No. 2008-281549 discloses a printing apparatus of an ink jet system including a colorimeter provided with pressing means for pressing a sheet having a color pattern printed thereon. Since the pressing means is provided, the sheet having a color pattern printed thereon can be securely pressed without causing any damage on the sheet, thus suppressing out-of-register between the color pattern and a colorimetric position.

The range of types of sheet to be used in a printing apparatus is enormous from a thin type to a thick type. In general, a thick sheet has a high rigidity. If a thick sheet is left wound for a long period of time, it is liable to remain tightly curled, and therefore, it is easily raised. In contrast, a thin sheet has a low rigidity. Even if a thin sheet is left wound for a long period of time, it hardly remains curled, and therefore, it is hardly raised. Such raising of a sheet is influenced also by temperature and humidity around the printing apparatus.

A colorimetric sensor performs colorimetry in a state pressed by the pressing means for pressing a sheet in the printing apparatus disclosed in Japanese Patent Laid-open No. 2008-281549. A loosely curled sheet has a small amount of sheet raised from a conveyance guide plate: in contrast, a tightly curled sheet has a large amount of sheet raised from the conveyance guide plate. Here, in the case where the pressing means presses the sheet, a difference in measurement position in a conveyance direction between a color pattern row printed on a loosely curled sheet and a color pattern row printed on a tightly curled sheet adversely arises. In this case, as a curl becomes tighter, the shift of a sheet is increased when the curl is remedied, and consequently, a measurement position on the sheet is deviated from an original position. This signifies degradation of accuracy of colorimetry.

### SUMMARY OF THE INVENTION

The present invention has been accomplished in view of the above-described problem. Therefore, an object of the present invention is to provide a printing apparatus and a colorimetric method capable of accurately measuring the color of a printed color pattern irrespective of the type of sheet to be used or the like, and further, of reducing unnecessary sheet consumption.

A printing apparatus according to the present invention is featured by including a print unit configured to perform printing on a sheet; a sensor configured to subject a color pattern formed on the sheet printed by the print unit to colorimetry; and a mechanism configured to press the sheet against a reference surface at the time of the colorimetry by the sensor, wherein in a case where the color pattern is printed by the print unit, a distance from a sheet tip to a region in which the color pattern is printed is varied based on at least any of information on the type of sheet to be used, temperature in the vicinity of the apparatus, and humidity in the vicinity of the apparatus, and after the color pattern is printed, the sheet is pressed by the mechanism in a state in which a part of the sheet including the sheet tip is suspended from the reference surface.

According to the present invention, a distance (i.e., an end margin) from a sheet tip to a region, in which a color pattern is printed on the sheet, is varied based on the type of sheet or the like. On the assumption that the sheet has a high rigidity, an increase in distance (i.e., a margin amount) can suppress the sheet from being raised, thus suppressing the degradation of colorimetric accuracy. In contrast, on the assumption that the sheet has a low rigidity, a decrease in distance (i.e., the margin amount) can reduce the margin amount at the sheet tip, that is, the consumption of a sheet that is not used in an original image printing operation.

Further features of the present invention will become apparent from the following description of exemplary embodiments (with reference to the attached drawings).

### BRIEF DESCRIPTION OF THE DRAWINGS

FIG. 1 is a cross-sectional view showing the overall configuration of an ink jet printing apparatus in an exemplary embodiment;

FIG. 2 is a cross-sectional view showing the configuration of a colorimetric unit;

FIG. 3 is a block diagram illustrating the configuration of a control system of the printing apparatus;

FIG. 4 is a flowchart illustrating procedures for performing colorimetry;

FIG. 5 is a table illustrating data on the length of an end margin; and

FIG. 6 is a diagram explaining a color pattern and the end margin.

### DESCRIPTION OF THE EMBODIMENTS

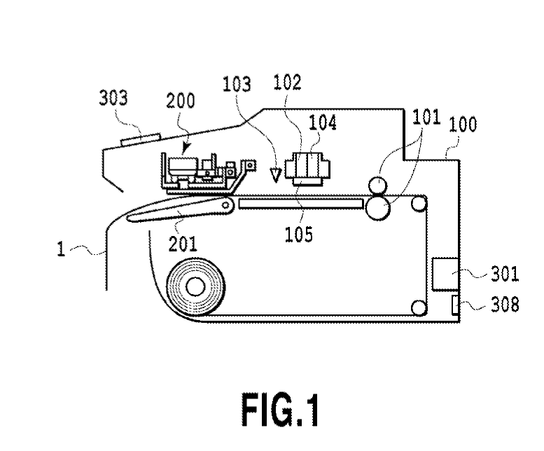

FIG. 1 is a cross-sectional view showing the overall configuration of a printing apparatus in the present exemplary embodiment. Incidentally, although an ink jet printing apparatus will be described below as an example, this does not limit the present invention. The present invention is applicable to printing apparatuses of an electrophotographic system, a thermal system, and other systems.

A printing unit for printing an image or a pattern on a sheet includes ink tanks 104 and a print head 105. The ink tanks 104 containing inks therein contain seven kinds of ink (seven colors, that is, black, cyan, magenta, yellow, gray, photo cyan, and photo magenta), respectively. To the print head 105 of an ink jet system are supplied these seven kinds of ink.

Here, the number of kinds of ink is not limited to seven, and therefore, it may be another number. Moreover, monochromatic printing may be performed with a plurality of kinds of gray ink having different densities without color inks. In the present specification, gray inks having different densities are regarded as different colors.

A conveyance roller pair 101 is rotated while holding a sheet 1 therein so as to convey (i.e., sub-scan) the sheet 1 transversely in a scan direction of the print head, and further, it has the function of retaining the sheet 1 therein. On a print unit 102 are mounted the detachable ink tanks 104 and the print head 105 of an ink jet system. The print unit 102 is such configured as to be movably reciprocated in a main scan direction. During the reciprocating motion of the print unit 102, the ink is ejected from the print head 105 onto the sheet 1, thus printing an image.

After printing and scanning in the main scan direction, the conveyance roller pair 101 is rotated to convey the sheet in a sub scan direction. The printing and scanning by the print head and the conveyance of the sheet are repeated, thereby completing printing an image (such as an original image or a color pattern for the purpose of calibration) on the sheet 1.

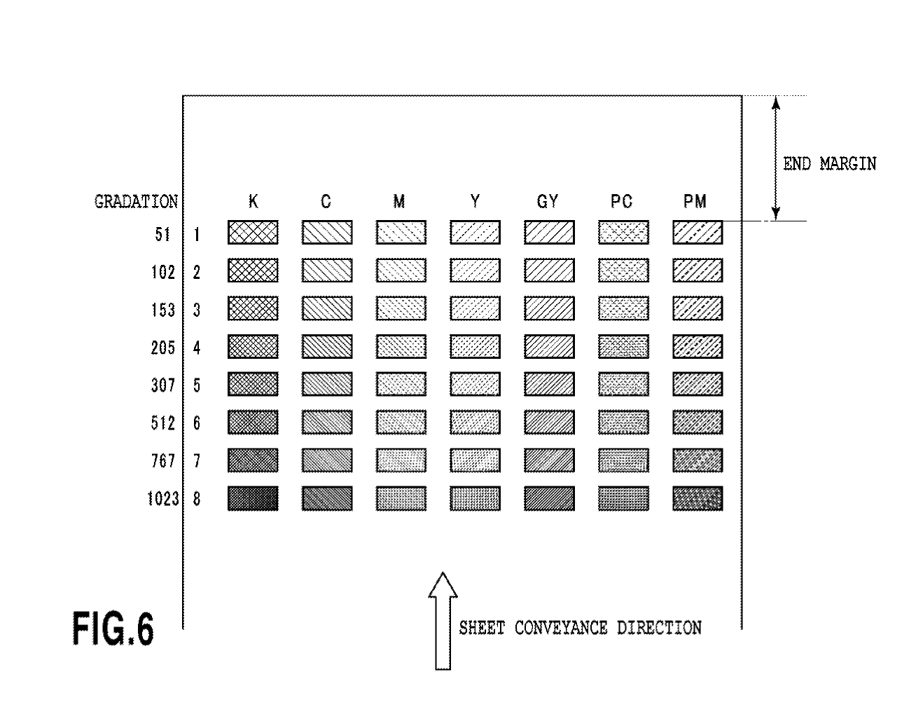

FIG. 6 illustrates an example of the arrangement of color patterns that are formed by the print unit. The color patterns are formed vertically and laterally, that is, in a two-dimensional arrangement. Seven ink colors are arranged in a lateral direction whereas gradations of each of the colors are arranged in a vertical direction. Patterns K1 to K8 are printed with a black ink; patterns C1 to C8, with a cyan ink; patterns M1 to M8, with a magenta ink; and patterns Y1 to Y8, with a yellow ink. Furthermore, patterns GY1 to GY8 are printed with a gray ink; patterns PC1 to PC8, with a photo cyan ink; and patterns PM1 to PM8, with a photo magenta ink.

In FIG. 6, numbers 1 to 8 for identifying the patterns sequentially correspond to density gradations (i.e., an ink print amount per unit area) of the patterns to be printed. Specifically, in the case of 10 bit data, 51, 102, 153, 205, 307, 512, 767, and 1023 gradations sequentially correspond to the numbers 1 to 8. Although the density gradations are arranged in sequence in the eight gradations in each of the colors in this example, other arrangements may be adopted. As described above, in the case where a plurality of gray and black inks are used, color patterns of a gray scale may be adopted.

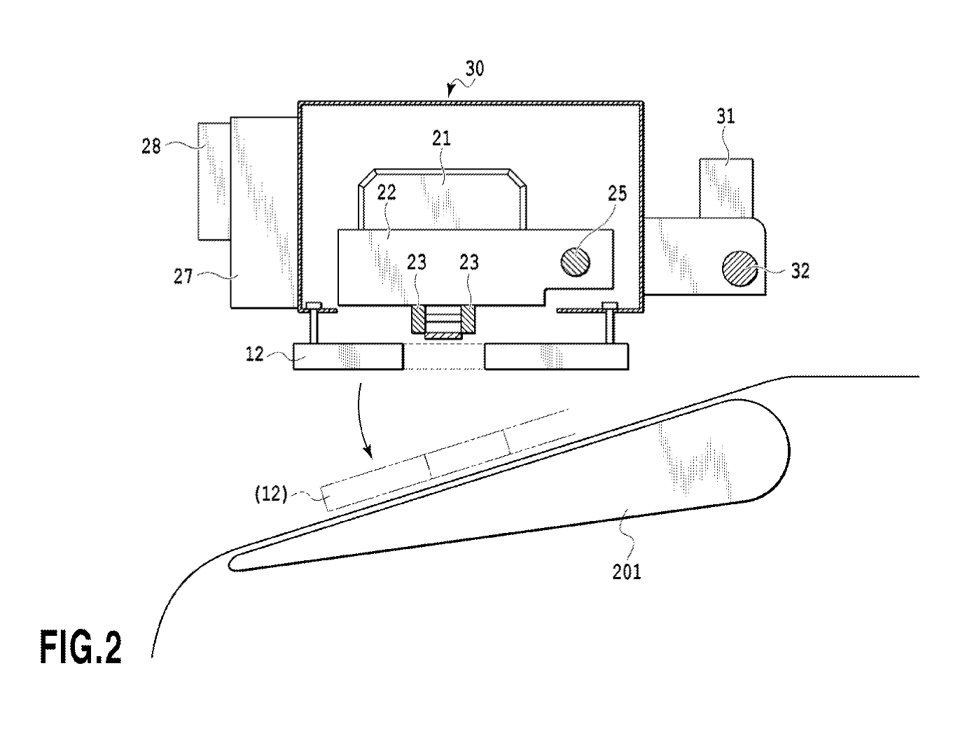

In this manner, the sheet 1 having a region in which the color pattern is formed is conveyed up to a colorimetric position at a colorimetric device 200 by the conveyance roller pair 101. At the time of colorimetry, the sheet 1 is pressed against the upper surface (i.e., a reference surface) of a reference guide 201 by a pressing plate 12 (refer to FIG. 2 as will become apparent below) (i.e., a pressing mechanism) at the colorimetric device 200. In this state, a colorimetric sensor 21 (refer to FIG. 2 as will become apparent below) is moved in a sheet width direction while measuring the density of the pattern formed in a colorimetric region of the sheet 1.

Upon completion of the colorimetry of one row of patterns, the pressing plate 12 is raised, and then, the sheet is stepwise conveyed by one row such that a next row of patterns is located under the colorimetric sensor. This operation is repeated, and thus, all of the patterns are subjected to the colorimetry. Upon completion of the colorimetry of all of the patterns formed in the colorimetric region, the sheet 1 is conveyed to a predetermined cut position, and then, is cut by a cutter 103. The cut sheet 1 is discharged via a sheet discharge guide to a sheet discharge basket disposed at a position at which the sheet falls.

Downstream in a conveyance direction of the colorimetric sensor 21 is provided a drying unit including a drying duct 27 (refer to FIG. 2 as will become apparent below) extending in the sheet width direction and a fan 28. Air generated by the fan 28 (refer to FIG. 2 as will become apparent below) is fed into the drying duct 27, and then, the air is uniformly blown from the drying duct 27 toward the surface of the sheet 1 having the color patterns printed thereon, thus promoting drying the color patterns. Consequently, the colorimetry can be performed without a long wait after the color patterns are printed.

A printing apparatus 100 further incorporates therein a hygrothermograph 308 (i.e., a detector) for measuring information on at least either one of temperature and humidity therearound. The information measured by the hygrothermograph 308 is utilized for adjusting an ink amount to be ejected from the print head, and further, for determining a print start position (i.e., the length of an end margin on a sheet) in forming the color patterns for the purpose of the colorimetry. The details will be described later.

FIG. 2 is a cross-sectional view showing the structure of the colorimetric device 200. A colorimetric unit 30 includes the colorimetric sensor 21, a sensor holder 22, a slide member 23, the pressing plate 12, a guide shaft 25, the drying duct 27, and the fan 28. Below the colorimetric unit 30 is disposed the reference guide 201 whose upper surface serves as a reference surface. The reference surface is slantwise inclined such that its downstream side becomes lower in a gravity direction.

The colorimetric sensor 21 is held by the sensor holder 22 (i.e., a carriage) that is movable in the direction of the normal to the surface of the sheet. The colorimetric sensor 21 irradiates the colorimetric color patterns formed on the sheet with a light beam, and then, detects the light beam reflected on the color patterns, so as to measure the colors. The sensor holder 22 is moved along the guide shaft 25. The colorimetric sensor 21 is moved in the sheet width direction, thereby achieving the colorimetry of one row of color patterns.

To the lower portion of the colorimetric unit 30 is fixed the pressing plate 12. The colorimetric unit 30 can be designed to be turned within a limited angular range on a rotary shaft 32 by a drive mechanism 31. Together with the turn, the pressing plate 12 is moved between a position indicated by a solid line (i.e., an upper position) and a position indicated by a broken line (i.e., a lower position) in FIG. 2.

When the color patterns are subjected to the colorimetry by the colorimetric sensor 21, the colorimetric unit 30 and the pressing plate 12 are turned downward, so as to press the sheet 1 located above the reference surface from above, thus letting the sheet match with the reference surface (a state (12) indicated by the broken line in FIG. 2). In this manner, even if a part of the sheet raised from the reference surface because the sheet is curved, the sheet matches with the reference surface so that the curl is remedied. Hence, the sheet is never raised at the colorimetric position, and therefore, the color patterns can be accurately measured. After the measurement of one row of patterns, the colorimetric unit 30 and the pressing plate 12 are turned upward, to be thus raised. And then, the sheet is stepwise fed by one row downstream such that the next pattern is located below the colorimetric sensor. This operation is repeated, and thus, all of the patterns are subjected to the colorimetry.

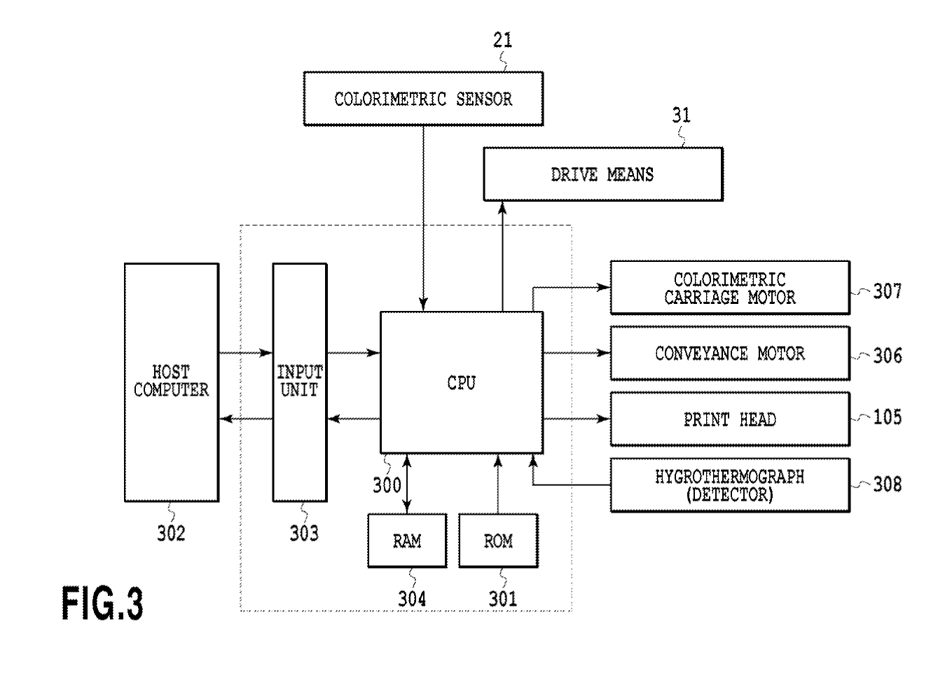

FIG. 3 is a block diagram illustrating the configuration of a control system of the printing apparatus. A CPU 300 is adapted to wholly control the printing and the colorimetry in accordance with a control program stored in a memory unit 301 (such as a ROM or a hard disk). The CPU 300 receives print data, print mode information on the type of sheet or the like, information on temperature and humidity around the printing apparatus, and colorimetric data from a host computer 302, an input unit 303, the hygrothermograph 308, and the colorimetric sensor 21, respectively. Based on these data, a print head 105, a conveyance motor 306, a colorimetric carriage motor 307, the drive means 31, and the like are controlled. Moreover, the CPU 300 can write or read the print data or the like in or from a RAM 304.

Incidentally, the present invention is not limited to a mode in which a user designates the type of sheet via the input unit 303, but is applicable to a mode in which a media sensor automatically may determine the type of sheet. Additionally, the present invention is not limited to a mode in which the hygrothermograph 308 is housed inside of the printing apparatus, but is applicable to a mode in which a printing apparatus may receive information on environment where the apparatus is installed, measured by an outside hygrothermograph.

Here, explanation will be made in detail on a problem to be solved by the present exemplary embodiment. The sheet is pressed by the pressing plate at the time of the colorimetry, thereby raising the following problem to be solved. As a curl of a sheet becomes tighter, the amount of sheet raised from the reference surface of the reference guide 201 becomes larger. While the sheet is pressed by the pressing plate so that the raising of the sheet is remedied, a part of the sheet is shifted downstream by an amount that a raised sheet is flattened.

Specifically, the color pattern to be measured is adversely shifted downstream of the colorimetric position. The shift amount is more increased as the amount of sheet raising is larger. When the shift amount is excessively increased, the color pattern to be measured is out of the colorimetric position at the sensor, thereby degrading the colorimetric accuracy. In the worst case, the colorimetry may become impossible.

In order to avoid such an adverse situation, before the sheet is pressed by the pressing plate 12, it is desirable that the curl of the sheet should be as small as possible, that is, the raising of the sheet should be small on the reference surface. In the present exemplary embodiment, in order to satisfy the above-described requirement, an end margin is provided in a predetermined amount at the end of the sheet, on which the color patterns are printed, and then, the patterns are formed. With a sufficient end margin, the tip of the sheet projecting downstream from the reference surface of the reference guide 201 suspends downward by its own weight of the sheet, so that the raising of the sheet on the reference surface can be suppressed by the weight effect, as shown in FIG. 2. As the length of the sheet suspended by its own weight of the sheet becomes greater, the sheet is pulled downstream by a greater force, so that the sheet is suppressed from being raised by the greater force.

With respect to the general characteristics of the sheet to be used in the printing apparatus, as the rigidity of the sheet to be used becomes lower, the curl tends to become tighter: in contrast, as the rigidity becomes higher, the curl tends to become looser. For example, the rigidity becomes lower in order of an ordinary sheet, a glossy sheet, and a coated sheet. In other words, the rigidity of a sheet to be used depends upon the type of sheet. Moreover, as ambient temperature becomes higher, the curl tends to become tighter: in contrast, the ambient temperature becomes lower, the curl tends to become looser. Additionally, as ambient humidity becomes higher, the curl tends to become tighter: in contrast, the ambient humidity becomes lower, the curl tends to become looser. In addition, the raising amount of the sheet from the reference surface also is varied according to the tightness of the curl of the sheet. Specifically, as the curl becomes tighter, the raising of the sheet tends to become larger.

A basic idea for solving the problem to be solved is determining the length of the end margin of the sheet so as to obtain a suspension amount of the tip of the sheet, required for suppressing the sheet raising amount to be estimated based on some parameters (such as the type of sheet, temperature, and humidity) that influence the tightness of the curl. When the pressing plate 12 presses the sheet in the state in which the color patterns in the most downstream row are located right under the sensor 21, a sheet raising suppressing force depends upon the length of the sheet projecting downstream from the reference surface. In view of this, the length of the end margin is determined.

FIG. 6 is the conceptual diagram illustrating the colorimetric color patterns printed on the sheet and the end margin. In the sheet conveyance direction (i.e., from below to above in FIG. 6), the plurality of patterns are regularly printed in arrangement from a position apart from the sheet tip by a predetermined distance. A range from the sheet tip to a region in which the patterns are formed (i.e., a range indicated by a double-headed arrow in FIG. 6) is referred to as the end margin. The print start position of the color pattern is varied, so that the distance can be varied.

This end margin is a mere blank where nothing is printed, and therefore, it may be regarded also as a useless region that is used for neither the original image formation nor the colorimetry of the color patterns. In view of this, in order to prevent sheets from being consumed more than required, it is desirable to set the end margin not to be shorter or longer. In the case where the curl is expected to be small, the end margin is set to the minimum requirement for the length.

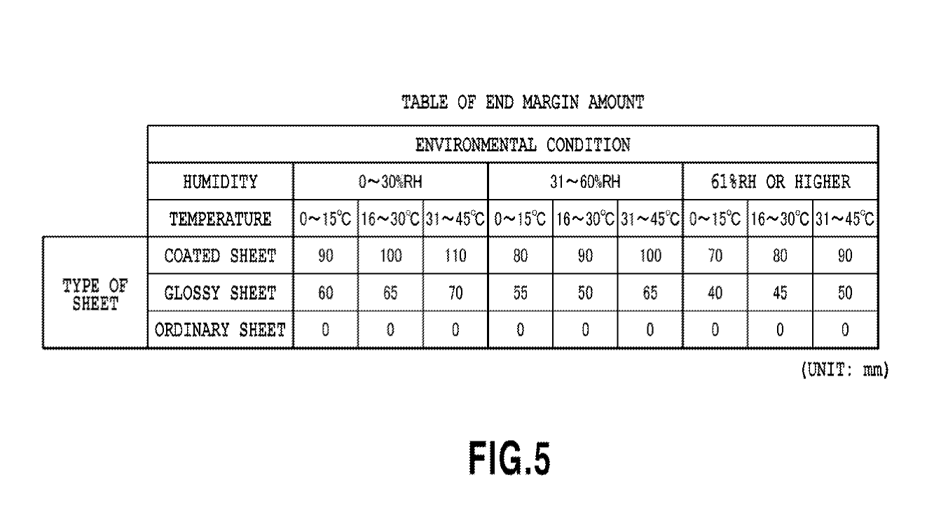

There is a method for acquiring an optimum length with reference to a prepared data table in setting the length of the end margin. FIG. 5 illustrates an example of a data table of the length of the end margin corresponding to the various types of sheet. The data table is stored in the memory unit in advance. The control unit (i.e., the CPU 300) refers to the data table based on the types of sheet to be used and information on the temperature and humidity, and then, acquires the proper length of an end margin.

In FIG. 5, the ranges of humidity and temperature are shown in rows whereas the types of sheet whose use is conceived are shown in a column. The range of humidity is classified into three categories: 0% RH to 30% RH, 31% RH to 60% RH, and 61% RH or higher. The range of temperature is classified into three categories: 0° C. to 15° C., 16° C. to 30° C., and 31° C. to 45° C. for each of the three categories of the humidity. Specifically, there are nine combinations in total of the humidity and the temperature with respect to a certain type of sheet. In contrast, the types of sheet are classified into three categories: a coated sheet, a glossy sheet, and an ordinary sheet. As a consequence, the combinations among the humidity, the temperature, and the type of sheet are 27 in total. Numerical values of the proper length of the end margin are determined with respect to all of the 27 combinations, thus making the data table. For example, in the case where the coated sheet is used in the environment of a temperature of 35° C. and a humidity of 15% RH, the length of the end margin is 110 mm with reference to the data table.

Here, the data table shown in FIG. 5 is merely one example, and therefore, it is not limited to this. Moreover, a method for acquiring the necessary length of the end margin is not limited to the mode utilizing the data table. For example, a computational equation for obtaining the length of an end margin is prepared. When the rigidity of a sheet and information on temperature and humidity are substituted into the computational equation, the length of an end margin may be obtained by calculation.

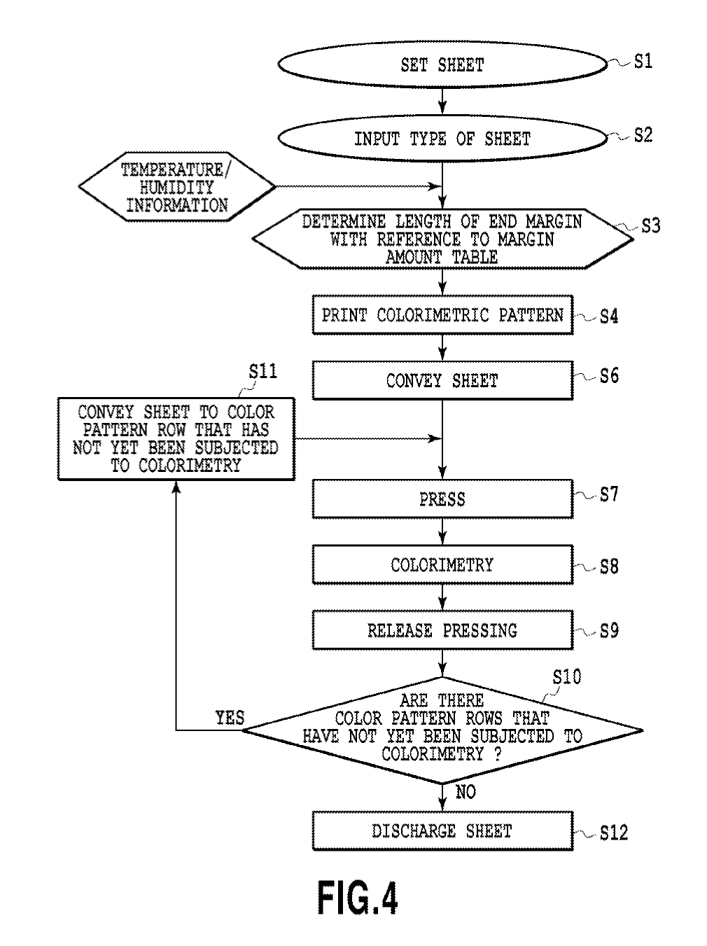

FIG. 4 is a flowchart illustrating procedures for performing the colorimetry of the color patterns. First, a user of the apparatus sets the sheet 1 in a printing apparatus body (step S1). And then, the user inputs the type of sheet via the input unit 303 (step S2). When the print data for use in printing the color pattern, print mode set information, and the like are transferred from the host computer 302 to a printer, the CPU 300 determines print control in accordance with the set information on a print mode. Moreover, the length of the end margin is determined with reference to the data table shown in FIG. 5, described above, based on the temperature/humidity information (at least either one of the temperature and the humidity) and the type of sheet (step S3).

Thereafter, a color pattern row is started to be printed at a position apart by a distance equivalent to the amount determined in step S3 from the tip of the sheet 1 (step S4). In other words, the print start position of the color pattern in the conveyance direction is varied, thus providing the end margin equivalent to the determined amount.

Upon completion of the printing operation, the sheet 1 is conveyed by the sheet conveyance motor 306 (step S6), and then, the printed color pattern row is moved to the colorimetric position. Thereafter, the means 31 for driving the pressing plate 12 is driven, so that the sheet is pressed against the reference surface of the reference guide 201 facing the sheet by the pressing plate 12 under pressure (step S7).

Subsequently, the colorimetric carriage motor 307 is driven, so that the sensor holder 22 is moved for scanning, thereby achieving the colorimetry of one line of the color pattern row. The resultant measurement data is transferred to the CPU 300 (step S8). Upon completion of the data transfer, the drive means 31 is driven, thereby releasing the pressing by the pressing plate 12 (step S9).

In the case where there are color pattern rows that have not yet been subjected to the colorimetry (step S10), the sheet 1 is conveyed until a color pattern row that has not yet subjected to the colorimetry is located at a colorimetric position (step S11). Thereafter, the pressing plate 12 presses the sheet again, and then, a colorimetric carriage is moved for scanning so as to perform the colorimetry, thus acquiring colorimetric data.

In this manner, the color pattern rows for the purpose of the acquirement of the colorimetric data are sequentially subjected to the colorimetry one by one. When the colorimetric data on all of the color pattern rows is acquired, the colorimetric information is stored in the RAM 304. Thereafter, the sheet 1 is conveyed up to a cut position, and then, is cut by the cutter. The sheet whose color pattern has been measured falls into the discharge basket by its own weight (step S12).

The acquired colorimetric information is transmitted to the host computer 302, followed by color calibration. During the color calibration, the amount of ink ejected from the print head is adjusted, and thus, an image is printed with a proper tint.

As described above, when the color pattern is printed in the present exemplary embodiment, the distance from the sheet tip to the region in which the color pattern is printed is varied based on parameters such as the type of sheet to be used and the information on the temperature and humidity in the vicinity of the apparatus, thus providing the proper length of the end margin. From another point of view, the position at which the color pattern is started to be printed in the sheet movement direction is varied, thus providing the proper length of the end margin. After the color pattern is printed, the sheet is pressed by the pressing plate in the state in which a part of the sheet including the sheet tip projects from the reference surface and is suspended.

On the assumption that the sheet has a high rigidity, an increase in distance (i.e., margin amount) can suppress the sheet from being raised from the reference surface by its own weight of the sheet, and further, the position of the pattern is less shifted when the sheet is pressed, thus suppressing the degradation of colorimetric accuracy. In contrast, on the assumption that the sheet has a low rigidity, a decrease in distance (i.e., margin amount) can reduce the margin amount at the sheet tip, that is, the consumption of a sheet that is not used in an original image printing operation. Experiments by the inventors revealed that since the problem to be solved was solved in the present exemplary embodiment, a sheet use amount was reduced down to about 40% at the maximum.

Incidentally, the parameters for use in determining the length of the end margin do not always need to include all of the type of sheet to be used, the temperature in the vicinity of the apparatus, and the humidity in the vicinity of the apparatus. The length of the end margin may be determined based on at least one piece of information among the parameters.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-020587, filed Feb. 5, 2013, which is hereby incorporated by reference herein in its entirety.

What is claimed is:

1. A printing apparatus comprising:
a print unit configured to perform printing on a sheet;
a sensor configured to subject a color pattern formed on the sheet printed by the print unit to colorimetry; and
a mechanism configured to press the sheet against a reference surface at the time of the colorimetry by the sensor,
wherein in a case where the color pattern is printed by the print unit, a distance from a sheet tip to a region in which the color pattern is printed is varied based on at least any of information on the type of sheet to be used, temperature in the vicinity of the apparatus, and humidity in the vicinity of the apparatus, and
after the color pattern is printed, the sheet is pressed by the mechanism in a state in which a part of the sheet including the sheet tip is suspended from the reference surface.

2. A printing apparatus according to claim 1, wherein a detecting unit configured to detect information on at least either one of the temperature and the humidity is housed inside of the printing apparatus.

3. A printing apparatus according to claim 1, further comprising an input unit, via which a user inputs the type of sheet.

4. A printing apparatus according to claim 1, wherein the print unit includes a print head of an ink jet system.

5. A colorimetric method comprising the steps of:
printing a color pattern on a sheet;
pressing the sheet having the color pattern formed thereon against a reference surface; and
subjecting the color pattern printed on the pressed sheet to colorimetry,
wherein in a case where the color pattern is printed, a position, at which the color pattern in a sheet movement direction is started to be printed, is varied based on at least any of information on the type of sheet to be used, temperature in the vicinity of an apparatus, and humidity in the vicinity of the apparatus.
